(19) United States
(12) Patent Application Publication
(10) Pub. No.: US 2018/0237731 A1
(43) Pub. Date: Aug. 23, 2018

(54) PRODUCING BEER USING A WORT CONCENTRATE

(71) Applicants: Peter Toombs, Charlottetown (CA); Brian Watson, Hamilton (NZ)

(72) Inventors: Peter Toombs, Charlottetown (CA); Brian Watson, Hamilton (NZ)

(21) Appl. No.: 15/956,415

(22) Filed: Apr. 18, 2018

Related U.S. Application Data
(63) Continuation of application No. 13/430,797, filed on Mar. 27, 2012, now abandoned.
(60) Provisional application No. 61/470,814, filed on Apr. 1, 2011.

(51) Int. Cl. C12C 7/28; C12C 11/11

(52) U.S. Cl. CPC C12C 7/28; C12C 2200/35; C12C 11/11

(57) ABSTRACT

A system including: at least one fermentation tank; at least one processor configured to execute computer-readable instructions stored on at least one computer-readable storage media to perform a method of producing beer, including the steps of: forming a mixture of a wort concentrate including hops and having a specific gravity of at least 1.085 kg/m³, with water and yeast in the fermentation tank; fermenting the mixture; cooling the fermented mixture to about zero degrees Celsius; adding yeast finings; and carbonating the filtered fermented mixture such that beer is produced. A computer-readable storage medium having stored thereon computer-readable instructions which when executed by at least one processor cause the at least one processor to perform a method of producing beer.

### CROSS-REFERENCE TO RELATED APPLICATION

This is a continuation application of U.S. patent application Ser. No. 13/430,797, tiled on Mar. 27, 2012 which claims priority from U.S. Provisional Application 61/470,814, filed Apr. 1, 2011, the entire disclosures of both applications herein incorporated by reference.

### BACKGROUND

Beer production is an age-old art; one that is often individualized for particular regions, tastes, styles, and the like. “Micro-brews” and uniquely crafted beers allow for more positive variations, as opposed to major beer manufacturers, in beer quality for a consumer.

Generally, beer production of beer starts by producing “sweet wort.” The sweet wort is formed by the addition of water to malted and unmalted crushed grain such as, but not limited to, barley to form a slurry or mash in a mash tun. Through the action of naturally occurring enzymes this mash is then converted into the sweet wort. Subsequently, the liquid in the sweet wort is drained from the mash tun and directed to a brew kettle where hops are added. The hopped liquid is then boiled in the brew kettle to produce a “hopped wort.” The final step in the brewing process involves the addition of yeast to cause fermentation to occur in a fermentation vessel, which in turn results in the production of alcohol.

Restaurants generally provide customers with beer by purchasing beer produced at a brewery, which is then shipped to a restaurant for sale, or, in a few instances, by producing the beer on-site at the restaurant. Restaurants that produce the beer on-site are typically referred to as “brew-pubs.” The vast majority of beer is brewed by the major breweries and then transported to various restaurants and served either in individual containers (bottles or cans) or out of kegs.

Some restaurants have made the large capital expenditures necessary to brew beer from start to finish on-site; however, the actual number of such restaurants is low because of the associated financial investment and liability in purchasing, operating, and maintaining a quality beer production facility in a restaurant. In addition, such restaurants may find this expansion difficult to achieve for several reasons, not the least of them being because of the cost involved in building new brewing facilities and/or the lack of skilled brew masters to oversee the brewing process in the individual restaurants. Consequently, often times a successful restaurant offering on-site brewing as well as other restaurant services is unable to expand beyond a single restaurant because of the capital cost involved with establishing another on-site brewery and/or the lack of a brew master to oversee the brewing operation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments describe techniques for producing beer using a wort concentrate. In various embodiments, a wort concentrate having a specific gravity of at least about 1.085 kg/m³ is produced and packaged predetermined amounts while at a temperature of about fifty-eight degrees C. or greater. In various embodiments, acid and sulphur can be added to the wort concentrate to produce a sulfur concentration of 10 ppm or more and a pH below about 3.0. Packages can then be shipped or otherwise transported or stored. In various embodiments, the wort concentrate is mixed with predetermined amounts of filtered water, an acid neutralizing solution, and yeast, and fermented for a predetermined time period. Various embodiments can further include cooling the fermented mixture to about zero degrees C. and storing the fermented mixture. In some embodiments, yeast finings are introduced and the fermented mixture is filtered and carbonated such that beer is produced.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 is a block diagram of an example process for producing wort concentrate in accordance with one or more embodiments;

FIG. 2 depicts an example process for packaging wort concentrate in accordance with one or more embodiments;

FIG. 3 is a block diagram of an example process for producing a fermented mixture from wort concentrate in accordance with one or more embodiments; and

FIG. 4 is a block diagram of an example system that can be used to implement one or more embodiments.

### DETAILED DESCRIPTION

### Overview

Various embodiments describe techniques for producing beer using a wort concentrate. In various embodiments, a wort concentrate having a specific gravity of at least about 1.085 kg/m³ is produced and packaged in predetermined amounts while at a temperature of about fifty-eight degrees C. or greater. In various embodiments, acid and sulphur can be added to the wort concentrate to produce a sulfur concentration of 10 ppm or more and a pH below about 3.0. Packages can then be shipped or otherwise transported or stored. In various embodiments, the wort concentrate is mixed with predetermined amounts of filtered water, an acid neutralizing solution, and yeast and fermented for a predetermined time period. Various embodiments can further include cooling the fermented mixture to about zero degrees C. and storing the fermented mixture. In some embodiments, yeast finings are introduced and the fermented mixture is filtered and carbonated such that beer is produced.

In the discussion that follows, a section entitled “Producing Wort Concentrate” describes various techniques for producing wort concentrate in accordance with one or more embodiments. Next, a section entitled “Packaging Wort Concentrate” describes various techniques for packaging wort concentrate in accordance with one or more embodiments. A section entitled “Producing Beer from Wort Concentrate” describes techniques for using packaged wort concentrate to produce beer for consumption. Finally, a section entitled “Example System” describes an example system that can be used to implement one or more embodiments.

Consider, now, an example process for producing wort concentrate in accordance with one or more embodiments.

### Producing Wort Concentrate

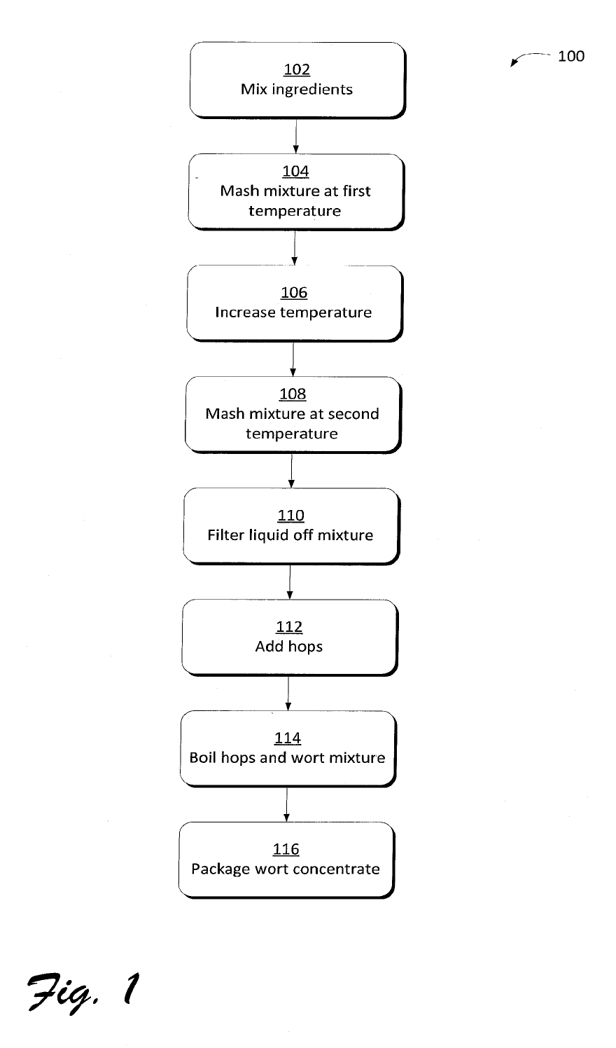

FIG. 1 is a block diagram of an example process 100 for producing wort concentrate in accordance with one or more embodiments.

Block 102 mixes ingredients. Ingredients can include malted grain and water. Malted grain can be, for example, barley, wheat, rice, or other grains. In some embodiments, the malted grain can be crushed or milled. Other ingredients can be added, depending on the particular embodiment. The ingredients can be mixed in a mash tun or other vessel.

Block 104 mashes the mixture of block 102 at a first temperature. This can be performed in any suitable way. In various embodiments, the first temperature is a temperature of approximately 65 degrees C. Mashing enables the enzymes in the grain to convert starches (e.g., long chain carbohydrates) from the grain into fermentable sugars. This conversion process is sometimes called “saccharification.” Fermentable sugars can include, for example, glucose, maltose, and malotriose. In various embodiments, the mixture is mashed for an amount of time between ten and thirty minutes. The particular time of mashing can vary depending on the particular embodiment.

Block 106 increases the temperature. This can be performed in any suitable way. For example, a brewer can increase the temperature manually or an automated system can be employed to increase the temperature to a temperature between 73 and 74 degrees C. The particular increase in temperature can vary depending on the specific embodiment.

Next, block 108 mashes the mixture at the second temperature. This can be performed in any suitable way. For example, the mixture can be mashed for an amount of time between about thirty and about ninety minutes at a temperature between 73 and 74 degrees C. This secondary mashing can produce fermentable sugars and/or non-fermentable sugars. Non-fermentable sugars, such as DP4 and DP3 for example, can contribute to the body and mouthfeel of the final beer product.

Block 110 filters liquid off the mixture. This can be performed in any suitable way. For example, the wort can be strained through the bottom of the mash tun in a process sometimes referred to as “lautering” and transferred into another vessel. Other methods of filtering the wort from the mash mixture can be used, depending on the particular embodiment.

Next, block 112 adds hops to the wort. This can be performed in any suitable way. For example, hops can be added, with or without other ingredients such as herbs or sugars, to the wort to add flavor, aroma, and bitterness.

Block 114 boils the hops and wort mixture. This can be performed in any suitable way. For example, the hops and wort mixture can be boiled in the brew kettle for a predetermined amount of time effective to convert hops from non-bitter compounds into bitter compounds. In various embodiments, the predetermined amount of time is between about 1 and about 3 hours. The particular amount of time can vary depending on the specific embodiment. In various embodiments, the hops and wort mixture is boiled effective to produce a wort concentrate having a specific gravity in a range from about 1.085 kg/m³ to about 1.095 kg/m³.

Finally, block 116 packages the wort concentrate. This can be performed in any suitable way, examples of which are provided above and below.

At least one result of process 100 is a wort concentration having a specific gravity in the range of about 1.085 kg/m³ to about 1.095 kg/m³. By contrast, traditional wort concentrations have a specific gravity in the range of about 1.038 kg/m³ to about 1.060 kg/m³. The increased specific gravity and concentration of the wort concentrate can be attributed at least in part to an increased boiling time over convention methods of wort production.

Having described an exemplary method of producing a wort concentrate, consider now a description of techniques for packaging the wort concentrate.

### Packaging Wort Concentrate

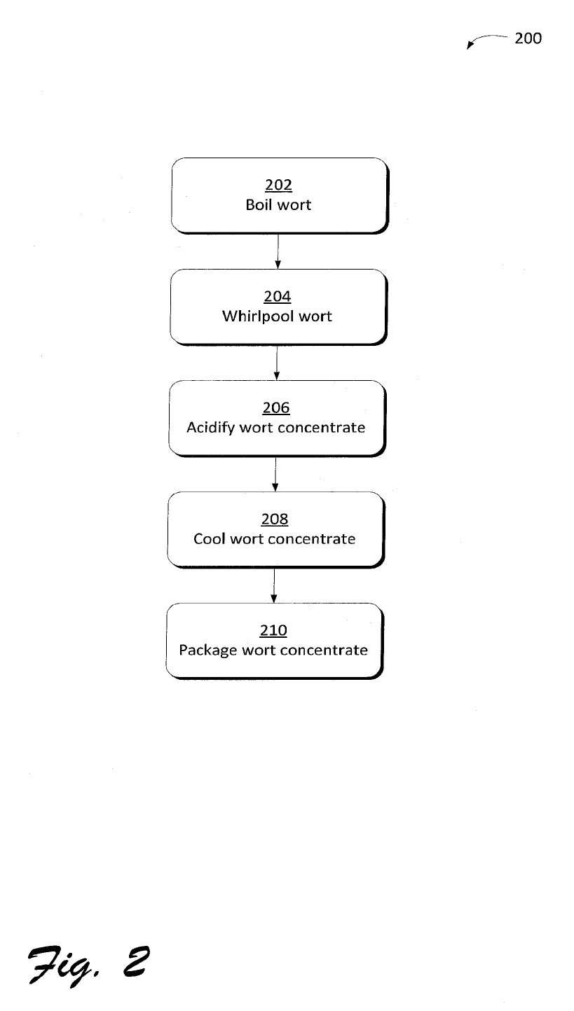

FIG. 2 illustrates an example process 200 for packing wort concentrate in accordance with one or more embodiments. Process 200 can be employed, for example, by block 116 in FIG. 1.

Block 202 boils the wort. This can be performed in any suitable way. For example, wort can be boiled with hops, such as described above in reference to block 114.

Next, block 204 whirlpools the wort. This cart be performed in any suitable way. For example, after boiling, the hopped wort can be settled to clarify, effective to separate out solid particles, including coagulated protein and hops compounds. In various embodiments, most or a majority of the solid particles are separated from the wort concentrate.

Block 206 acidifies the wort concentrate. This can be performed in any suitable way. For example, phosphoric or lactic acid can be added to the wort effective to acidifiy the wort to a pH of between about 2.0 and about 3.0. In various embodiments, sulfur is added to a level of 10 ppm or more. This can be performed in any suitable way. For example, sodium metabisulphite and/or potassium metabisulphite can be added in an amount effective to adjust the sulfur level to 10 ppm or more.

Next, block 208 cools the wort concentrate. This can be performed in any suitable way. Few example, the wort can be transferred from the whirlpool through a heat exchanger into a fermenter for cooling. Other methods of cooling wort concentrate can be used depending on the particular embodiment. In various embodiments, the wort concentrate is cooled to a temperature between about 58 and about 60 degrees C.

Finally, block 210 packages the wort concentrate. This can be performed in any suitable way. For example, the wort concentrate can be packaged and shipped in predetermined sizes, weights, or the like. For example, the wort concentrate can be packaged into 20 or 25 liter bags in boxes or a suitable one-way vessel. In various embodiments, the wort concentrate is packaged at a temperature between about 58 degrees C. and about 60 degrees C.

Process 200 can be used to package the wort concentrate such that the wort concentrate is substantially microbiologically stabilized. While various techniques included in process 200 can contribute to the stabilization and sterilization of the wort concentrate, a substantially microbiologically stable wort concentration can be achieved by using less than all of these techniques. For example, packaging the wort at a temperature between about 58 degrees C. and about 60 degrees C. can have a pasteurization effect. As another example, acidification of the wort concentration to a pH of between about 2.0 and about 3.0 can have a deleterious effect on bacteria and yeast to minimize or even prevent bacterial and/or yeast growth or survival. In some embodiments, alternative techniques may be employed.

Once packaged, the wort concentrate can be shipped to a retail outlet, such as a restaurant, bar, store, or the like, for use in producing beer.

### Producing Beer from Wort Concentrate

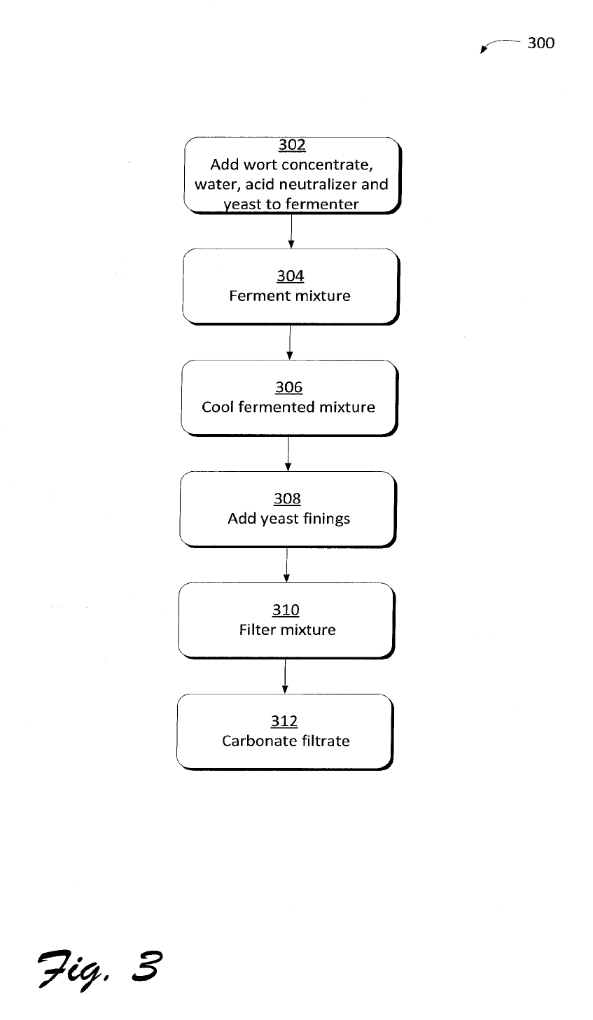

FIG. 3 is a block diagram of an example process 300 for producing beer from wort concentrate. The wort concentrate can be, for example, the wort concentrate produced by process 100 and packaged by process 200. In various embodiments, the wort concentrate can be selected based upon the end-type of beer desired, such as, for example, lager, dry, amber, stout, wheat, or the like. In various embodiments, process 300 can be performed by an automated system.

Block 302 adds the wort concentrate, water, acid neutralizer, and yeast to a fermenter. In some embodiments, other ingredients may also be added. This can be performed in any suitable way. For example, a user can select a recipe from a system screen and a pre-determined amount of wort concentrate can be pumped into a fermentation tank according to the selected recipe. Filtered water, an acid neutralizing solution, and yeast can also be added to the fermentation tank. This can be performed by a user or automatically by the system. In embodiments when the mixture is formed by a system, the system can receive a user selection of a recipe and cause an appropriate amount of each ingredient to be added to the tank.

Block 304 ferments the mixture. This can be performed in any suitable way. For example, in some embodiments, a user can push a “start” button when all ingredients have been added by block 302, or the system can automatically start fermenting upon the addition of ingredients. In various embodiments, temperature and carbon dioxide evolution are monitored during fermentation. Carbon dioxide evolution can be calibrated against specific gravity drop and subsequent alcohol development through a mass flow meter. In various embodiments, the mixture is fermented until carbon dioxide evolution reaches a pre-determined level.

Next, block 306 cools the fermented mixture. This can be performed in any suitable way. For example, when monitored carbon dioxide levels indicate fermentation is substantially complete, temperature of the fermentation tank can be decreased effective to cool the fermented mixture to a temperature between about zero and about four degrees C. in various embodiments, the fermented mixture is cooled at a temperature between about zero and about four degrees C. for about five to seven days. The time and temperature of cooling can vary depending on the particular embodiment.

Block 308 adds yeast finings. This can be performed in any suitable way. For example, after discharging waste yeast and cleaning system lines, yeast finings can be introduced into the fermentation tank. In various embodiments, yeast finings are added to the fermented mixture and the mixture is stored for about twenty-four hours.

Next, block 310 filters the mixture. This can be performed in any suitable way. For example, the mixture can be filtered into a bright tank or another vessel. In various embodiments, filtration can occur automatically. In some embodiments, a pH meter, flowmeter, and pressure transducers can be used to monitor filtration.

Finally, block 312 carbonates the filtrate. This can be performed in any suitable way. For example, a carbon dioxide and time dependent regime can be implemented automatically upon transfer of the filtrate into the bright tank. Upon carbonation, the beer is ready for consumption. The beer can be, for example, packaged into cans, bottles, or kegs, or can be otherwise prepared for consumption.

The techniques described above can be implemented to produce beer from a wort concentrate. In various embodiments, the techniques can be implemented by an automatic system such that a brew master need not be on-site to produce the beer. Consider the following example system that can be used to implement one or more embodiments.

### Example System

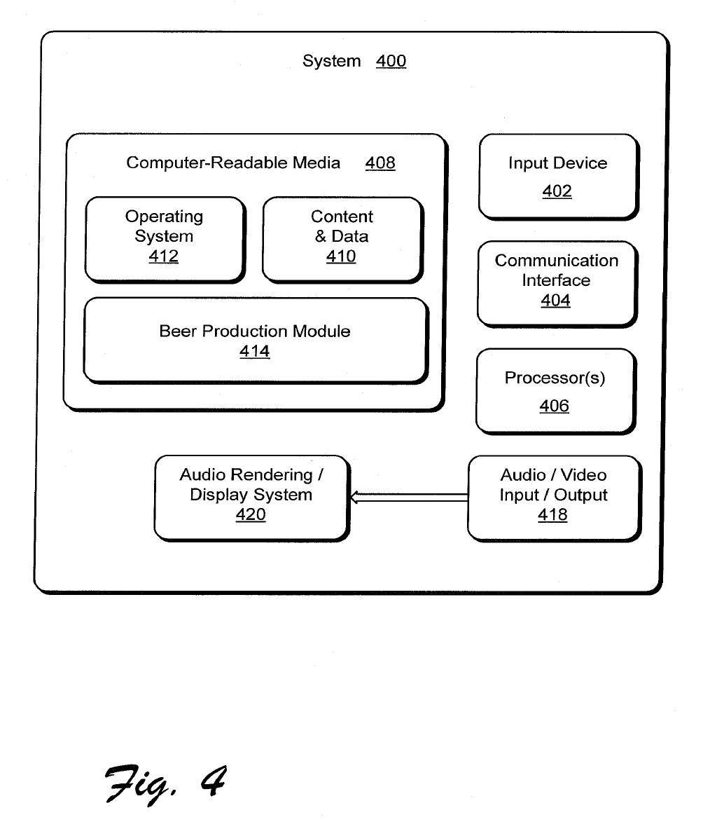

FIG. 4 depicts an example system 400 that can be used to implement one or more embodiments. For example, system 400 can be used to automatically produce beer from wort concentrate, such as described in example process 300.

System 400 includes input device 402 that may include Internet Protocol (IP) input devices as well as other input devices, such as a keyboard. Other input devices can be used, such as a pressure transducer, pH meter, flow meter, and the like. System 400 further includes communication interface 404 that can be implemented as any one or more of a wireless interface, any type of network interface, and as any other type of communication interface. Through communication interface 404, system 400 can direct other components, such as fermentation tanks, bright tanks, filtration components, and the like, to be configured according to particular parameters. A network interface provides a connection between system 400 and a communication network by which other electronic and computing devices can communicate data with system 400. A wireless interface can enable system 400 to operate as a mobile device for wireless communications.

System 400 also includes one or more processors 406 (e.g., any of microprocessors, controllers, and the like) which process various computer-executable instructions to control the operation of system 400 and to communicate with other electronic devices. System 400 can be implemented with computer-readable media 408, such as one or more memory components, examples of which include random access memory (RAM) and non-volatile memory (e.g., any one or more of a read-only memory (ROM), flash memory, EPROM, EEPROM, etc.). A disk storage device may be implemented as any type of magnetic or optical storage device, such as a hard disk drive, a recordable and/or rewriteable compact disc (CD), any type of a digital versatile disc (DVD), and the like.

Computer-readable media 408 provides data storage to store content and data 410, as well as device executable modules and any other types of information and/or data related to operational aspects of system 400. The data storage to store content and data 410 can be, for example, storage of recipes for producing beer from wort concentrate and production routines to produce the beer. For example, various routines for times and temperatures of the fermentation tank can be stored as content and data 410. One such configuration of a computer-readable medium is signal bearing medium and thus is configured to transmit the instructions (e.g., as a carrier wave) to the hardware of the computing device. The computer-readable medium may also be configured as a computer-readable storage medium and thus is not a signal bearing medium. Examples of a computer-readable storage medium include a random access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

An operating system 412 can be maintained as a computer executable module with the computer-readable media 408 and executed on processor 406. Device executable modules can also include a beer production module 414 as described above and below.

Beer production module 414 can be implemented to control various facets of beer production, such as described in process 300. For example, beer production module 414 can control dilution, fermentation, filtration, transfers of filtrate and mixtures between vessels, carbonation, and cleaning. In various embodiments, beer production module 414 monitors carbon dioxide evolution and, upon detecting that a pre-determined amount of carbon dioxide has been released into the atmosphere, can shut off the gas valve effective to use additional carbon dioxide generated to pre-carbonate the beer. In various embodiments, the beer is pre-carbonated to a level of 2.0-2.6 (volume/volume), and is measured by an input device 402, such as a pressure transducer.

In addition to measuring carbon dioxide evolution, beer production module 414 is configured to monitor alcohol formation and a drop in the specific gravity of the mixture. For example, given static state conditions of volume and temperature, beer production module 414 can monitor the alcohol formation and specific gravity drop through evolution of carbon dioxide. When the appropriate alcohol content has been reached, beer production module 414 can cause the fermenter to be cooled and arrest further fermentation. In various embodiments, beer production module 414 causes the fermenter to be cooled when the specific gravity of the beer is about 1.045 kg/m³.

Beer production module 414 can also be configured to cause a beer brewing system, including fermenters, transfer lines, filtration equipment, and bright tanks, to be cleaned. For example, in addition to being connected to each of these components via communication interface 404, system 400 can be connected to a clean water tank in which cleaning solutions can be made. Beer production module 414 can direct a cleaning solution to be transferred to one or more specific components, implement and time a cleaning regime, and cause the component to be sanitized.

System 400 also includes an audio and/or video input/output 418 that provides audio and/or video data to an audio rendering and/or display system 420. The audio rendering and/or display system 420 can be implemented as integrated component(s) of the example system 400, and can include any components that process, display, and/or otherwise render audio, video, and image data.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A system including:
at least one fermentation tank;
at least one processor configured to execute computer-readable instructions stored on at least one computer-readable storage media to perform a method of producing beer, including the steps of:
forming a mixture of a wort concentrate including hops and having a specific gravity of at least 1.085 kg/m³, with water and yeast in the fermentation tank;
fermenting the mixture;
cooling the fermented mixture to about zero degrees C.;
adding yeast finings; and
carbonating the filtered fermented mixture such that beer is produced.

2. The system of claim 1, wherein the processor is configured to:
receive a user selection of a recipe; and
cause an appropriate amount of wort concentrate, water, and yeast to be added to the fermentation tank for forming of the mixture according to the recipe.

3. The system of claim 1, the processor being further configured to monitor the evolution of carbon dioxide effective to enable a determination to be made that fermentation is complete.

3. The system of claim 1, the processor being configured to control filtering of the fermented mixture following addition of the yeast finings.

4. The system of claim 1, the processor being configured to store the fermented mixture between about zero and about four degrees C. for about five to seven days before adding yeast finings.

6. A method for producing beer including:
forming a mixture of a wort concentrate including hops and having a specific gravity of at least 1.085 kg/m³, with water and yeast;
fermenting the mixture;
monitoring fermentation conditions, and on determining with at least one processor that predetermined fermentation conditions have been met, cooling the fermented mixture to between about zero and about four degrees Celsius;
adding yeast finings; and
carbonating the fermented mixture such that beer is produced. The method of claim 6, further including:
storing the fermented mixture between about zero and about four degrees Celsius for about five to seven days before adding yeast finings.

8. The method of claim 6, wherein the wort concentrate has a sulfur level of about 10 ppm or greater.

9. The method of claim 6, wherein the specific gravity of the beer is about 1.045 kg/m³.

10. The method of claim 6, wherein the step of forming the mixture includes the addition of an acid neutralizing solution.

11. The method of claim 10, wherein the wort concentrate has a pH of about 2.0-3.0.

12. The method of claim 6, wherein the step of forming the mixture includes:
receiving a user selection of a recipe; and
causing an appropriate amount of wort concentrate, water, and yeast to be added to a tank according to the recipe.

13. The method of claim 6, including the step of filtering the fermented mixture following addition of the yeast linings.

14. A computer-readable storage medium having stored thereon computer-readable instructions which when executed by at least one processor cause the at least one processor to perform a method of producing beer, the computer-readable instructions comprising:
instructions for forming a mixture of a wort concentrate including hops and having a specific gravity of at least 1.085 kg/m³ with water, and yeast;
instructions for fermenting the mixture;
instructions for monitoring fermentation conditions, and on determining with at least one processor that predetermined fermentation conditions have been met, cooling the fermented mixture to between about zero and about four degrees Celsius;
instructions for adding yeast finings; and
instructions for carbonating the fermented mixture such that beer is produced.
